(19) United States
(12) Patent Application Publication
(10) Pub. No.: US 2026/0072403 A1
(43) Pub. Date: Mar. 12, 2026

(54) THERMALLY-ACTUATED MICROMECHANICAL DEVICE, IN PARTICULAR FOR HOROLOGY

(71) Applicant: ETA SA Manufacture Horlogère Suisse, Grenchen (CH)

(72) Inventors: Julien CHRISTAN, Bienne (CH); Mohammad Hussein KAHROBAIYAN, Boudevillies (CH)

(73) Assignee: ETA SA Manufacture Horlogère Suisse, Grenchen (CH)

(21) Appl. No.: 19/289,411

(22) Filed: Aug. 4, 2025

(30) Foreign Application Priority Data
Sep. 12, 2024 (EP) 24200028.9

(51) Int. Cl. G04B 18/08

(52) U.S. Cl. CPC G04B 18/08

(57) ABSTRACT

A thermally-actuated micromechanical device (1), in particular for a horology movement, the micromechanical device (1) including a first mechanically-actuatable mobile (3) and a second mechanically-actuatable mobile (4), the second mobile (4) being translationally mobile relative to the first mobile (3) between a coupled position, in which the first mobile (3) mechanically engages with the second mobile (4) to actuate it, and a locked position, in which the second mobile (4) cannot engage mechanically with the first mobile (3), the micromechanical device (1) including a support (5) on which the second mobile (4) is mounted, wherein the support (5) is thermally distortable to move the second mobile (4) from the locked position to the coupled position and/or inversely.

### CROSS REFERENCE TO RELATED APPLICATIONS

This application claims priority to European Patent Application No. 24200028.9, filed on Sep. 12, 2024, the entire contents of which are incorporated herein by reference.

### TECHNICAL FIELD OF THE INVENTION

The invention relates to the field of point-actuatable micromechanical devices, and more specifically to the field of thermally-actuated micromechanical devices, particularly for horology.

### TECHNOLOGICAL BACKGROUND

In gear mechanisms, it may be necessary to use a point-actuatable micromechanical device. More specifically, in the horology field, there are mechanisms for timing a particular horology module, for example the time or the date, or for setting the rate of the movement.

These mechanisms are point-actuated and mechanically engage toothed wheels.

To actuate them, these mechanisms either require a device accessible from outside the timepiece, such as a winding crown and stem for setting the time, or they require the case of the timepiece to be opened to access the timepiece module, for example when setting the rate.

Actuation from outside the case makes the movement more complex, as components have to be added to the movement to allow access to the horology module to be actuated. The case must also be water-resistant.

Opening the case changes the pressure inside the case, which has negative repercussions on the rate of the regulating organ.

There are micromechanical actuating devices that can be actuated from outside the case, without opening the case. For example, document DE1720495 presents a magnetic actuator, while document CH504030 presents a thermal actuator and document EP3118693 presents a photo actuator.

However, these micromechanically-actuated devices do not enable sufficient setting precision to be achieved.

### SUMMARY OF THE INVENTION

The present invention aims to remedy all or part of the drawbacks mentioned above by providing a micromechanical device for accurate setting that can be actuated from outside a case.

To this end, the invention relates to a thermally-actuated micromechanical device, in particular for a horology movement, the micromechanical device comprising a first mechanically-actuatable mobile and a second mechanically-actuatable mobile, the second mobile being translationally mobile relative to the first mobile between a coupled position, in which the first mobile mechanically engages with the second mobile to actuate it, and a locked disconnected position, in which the second mobile cannot engage mechanically with the first mobile, the micromechanical device comprising a support on which the second mobile is mounted.

The invention is remarkable in that the support can be thermally distorted to move the second mobile from the locked position to the coupled position and/or inversely.

The invention provides a micromechanical device for mechanically connecting two mobiles by means of thermal actuation. As a result, no supplementary mechanical mechanism is required to connect the two mobiles.

The device is simple to manufacture and can be actuated remotely by heating the support.

Moreover, such a device can be actuated from outside a case, for example in the case of a timepiece for which it is desirable to adjust the setting without opening the case. The micromechanical device can in fact be actuated by heating, leaving the case closed.

According to a particular embodiment of the invention, the support comprises at least in part, preferably completely, a memory material that is thermally distortable when it exceeds a threshold temperature.

According to a particular embodiment of the invention, the threshold temperature is comprised between 60° C. and 80° C., preferably between 65° C. and 75° C., or even substantially equal to 70° C.

According to a particular embodiment of the invention, the support is a lever.

According to a particular embodiment of the invention, the lever comprises a curved portion, the lever straightening to move the second mobile from the locked position to the coupled position.

According to a particular embodiment of the invention, the second mobile is arranged in or in the immediate vicinity of the curved portion of the lever.

According to a particular embodiment of the invention, the micromechanical device comprises an arbor arranged perpendicularly to a first end of the lever, to form a pivot around which the lever can turn.

According to a particular embodiment of the invention, the support comprises a pinion meshing with the second mobile.

According to a particular embodiment of the invention, the first mobile is a gear wheel.

According to a particular embodiment of the invention, the second mobile is a gear wheel.

According to a particular embodiment of the invention, the micromechanical device comprises a return spring for pushing the second mobile back into the locked position.

The invention also relates to a horology movement comprising such a micromechanical device.

According to a particular embodiment of the invention, the horology movement comprises a plate or a bar provided with a bed for the support.

According to a particular embodiment of the invention, the bed comprises a flange forming a support for a second end of the lever.

The invention also relates to a timepiece comprising such a horology movement.

### BRIEF DESCRIPTION OF THE FIGURES

The purposes, advantages and characteristics of the present invention will become apparent on reading several embodiments provided solely by way of non-limiting examples, with reference to the appended drawings in which:

FIG. 1 is a schematic perspective view of part of a horology movement comprising a thermally-actuated micromechanical device in a first configuration,

FIG. 2 is a schematic perspective view of the part of the horology movement in FIG. 1, in which the thermally-actuated micromechanical device is in a second configuration,

FIG. 3 is a schematic perspective view of part of a thermally-actuated micromechanical device,

FIG. 4 is a schematic top view of the part of a thermally-actuated micromechanical device, and

FIG. 5 is a schematic perspective view of part of a setting mechanism driven by the micromechanical device according to the invention.

### DETAILED DESCRIPTION OF THE INVENTION

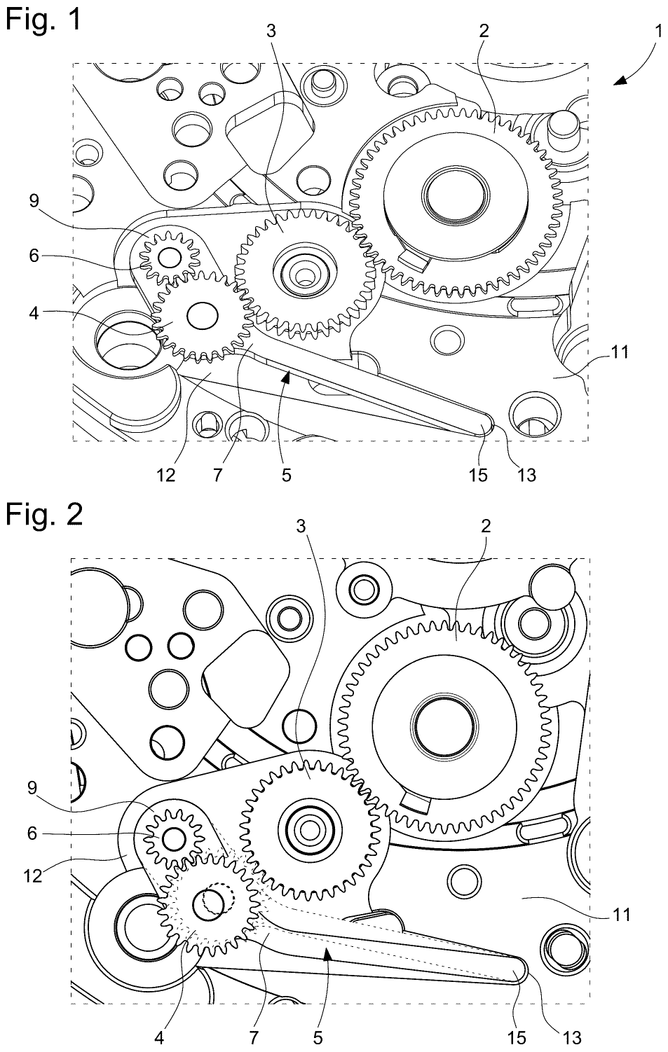

FIGS. 1 and 2 show a schematic view of an embodiment of a thermally-actuated device 1 designed to be fitted in a horology movement 10. The horology movement 10 comprises a plate 11 and a bed 12 arranged in the plate 11 to accommodate the thermally-actuated device 1.

The horology movement 10 further comprises a main setting mobile 2, the main setting mobile 2 driving a horology module mechanism.

The main mobile 2 is, for example, a date drive wheel. Such a wheel has a high gear ratio with the stem and makes it possible to achieve precise setting resolution.

The horology module comprises, for example, a mechanism for setting the rate of the horology movement, which is actuated by a cam 14 as seen in FIG. 5. This means that the setting mechanism functions when the main mobile 2 is actuated.

The thermally-actuated device 1 further comprises a first mechanical mobile 3, in this case a first gear wheel, and a second mechanical mobile 4, in this case a second mechanical mobile.

The first mechanical mobile 3 meshes with the main mobile 2 so that it can be actuated. Thus, turning the main mobile 2 turns the first mechanical mobile 3 to actuate the setting mechanism on the horology module associated with the first mechanical mobile 3.

The second mechanical mobile 4 is mobile relative to the first mechanical mobile 3 between a coupled position, in which the first mechanical mobile 3 meshes with the second mechanical mobile 4, and a locked position, in which the first mechanical mobile 3 does not mesh with the second mechanical mobile 4.

To this end, the second mechanical mobile 4 is mounted on a support 5, configured to be able to move the second mechanical mobile 4 from the locked position to the coupled position, and inversely.

In this embodiment, the support 5 is a substantially longitudinal lever. The lever comprises a curved portion 7 joining two substantially straight portions. The lever comprises two ends 9, 15.

Preferably, the second mechanical mobile 4 is arranged in the curved portion 7 of the lever, which moves over a longer distance than the straight portions.

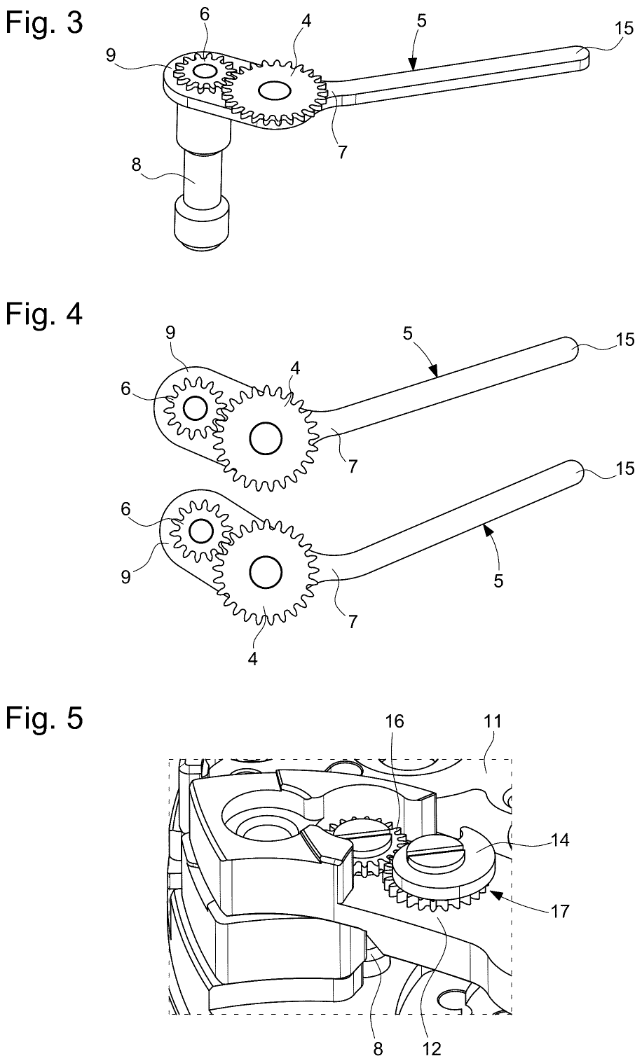

In FIG. 3, the support 5 also comprises a pinion 6 and arbor 8, arranged at a first end 9 of the lever, the pinion 6 being mounted on the arbor 8. The arbor 8 is fitted through the plate 11 and through the support 5. The first end 9 of the lever is thus held in the bed 12. However, the arbor 8 forms a pivot around which the lever can turn.

The pinion 6 meshes with the second mechanical mobile 4, regardless of its position. When the second mechanical mobile 4 is driven, the pinion 6 actuates the arbor. The arbor 8 is joined to a gear system, not shown in the figures, which is actuatable, preferably point-actuatable, for example by the wearer of the timepiece comprising this movement.

According to the invention, the support 5 is thermally distortable between two configurations: A first configuration in which the second mechanical mobile 4 is in the coupled position, and a second configuration in which the second mechanical mobile 4 is in the locked position, as shown in FIG. 2.

More specifically, the support 5 distorts thermally when it exceeds a threshold temperature. Preferably, the support 5 distorts in the coupled position when the threshold temperature is exceeded.

To this end, the support 5 comprises a shape memory material. Such a material distorts above a threshold temperature and returns to its initial shape below this threshold temperature.

Different types of shape memory materials are possible.

For example, a copper-based alloy with the following compositions by weight can be used:
Cu between 64.5 and 85%, Zn between 9.5 and 25% and Al between 4.5 and 10%,
Cu between 79.5 and 84%, Al between 12.5 and 14% and Ni between 2.5 and 6%,
Cu between 87 and 88%, Al between 11 and 12% and Be between 0.3 and 0.7%.

There are also gold-based alloys, such as 50Au40Ti10Zr, 52Au47Ti1Zr and 50Au45Ti3Zr2Nb, with the following compositions, for example, in atomic percentage:
46 to 55 at % gold,
38 to 47 at % titanium,
0.1 to 15 at % zirconium,
0 to 5 at % niobium.

Nickel and titanium alloys, such as Nitinol, or even plastics, can also be used as shape memory materials for the support.

Thus, if the temperature rises above the threshold temperature, the lever straightens and moves the second mechanical mobile 4 from the locked position to the coupled position so that it can be driven by the first mechanical mobile 3 and therefore by the main mobile 2. When the lever is distorted, the ends 9, 15 of the lever remain in substantially the same position. However, the curvature of the curved portion 7 of the lever decreases.

The curved portion 7 moves in towards the first mechanical mobile 4.

The bed 12 on the plate 11 comprises a flange 13 forming a support for the second end 15 of the lever. The bed 12 is designed to allow for the distortion of the lever. In this case, the shape of the bed is enlarged from the flange 13 for the second end 15. The curved portion 7, and therefore the second mechanical mobile 4, moves in the bed 12 under the effect of the distortion.

When the temperature returns to below the threshold temperature, the lever returns to its original shape, with a more pronounced curvature. The second mechanical mobile 4 is then again separated from the first mechanical mobile 3 and can no longer be driven by the latter.

The threshold temperature is comprised, for example, between 60° C. and 80° C., preferably between 65° C. and 75° C., or even substantially equal to 70° C. This temperature range is sufficiently high to avoid unwanted triggering of the material distortion, for example due to a high external temperature, yet not too high so as to avoid the risk of deteriorating the elements in the movement, such as the oil.

Alternatively, the threshold temperature is chosen in the negative temperature range, for example below −20°C.

As a variant, the chosen material has two different threshold temperatures, a first threshold temperature for moving from the locked position to the coupled position, and a second threshold temperature for moving from the coupled position to the locked position.

For improved transitions between the positions, in particular for returning to the locked position, the micromechanical device can comprise a return spring (not shown in the figures), to push the lever and thus the second mechanical mobile back to the locked position.

FIG. 5 shows part of the setting mechanism driven by the thermally-actuated micromechanical device. A third gear mobile 16 is mounted at the other end of the arbor 8 and meshes with a cam mobile 17, comprising the cam 14. The cam 14 interacts with another part of the setting mechanism, not shown in the figure, comprising a feeler spindle or a mobile ratchet and which enables the rate, for example, to be set. The cam 4 is thus driven when the first mobile 3 is in the coupled position.

In a variant embodiment, not shown in the figures, the cam mobile is replaced by a mobile fitted with an eccentric. Such an eccentric is able to engage with a setting mechanism cooperating with said eccentric.

A horology movement fitted with such a micromechanical device 1 can be fitted in a timepiece. To this end, the timepiece comprises a case closed by a back.

The back is transparent, for example, to allow laser radiation to pass through to the horology movement, in particular to the support for the micromechanical device. This laser radiation is configured so that it can heat the micromechanical device support in order to distort it.

Naturally, the invention is not limited to the embodiments of the regulating organs described with reference to the figures, and variants could be envisaged without departing from the scope of the invention.

1. A thermally-actuated micromechanical device (1) for a horology movement, the micromechanical device (1) comprising:
a first mechanically-actuatable mobile (3);
a second mechanically-actuatable mobile (4), the second mobile (4) being translationally mobile relative to the first mobile (3) between a coupled position, in which the first mobile (3) mechanically engages with the second mobile (4) to actuate it, and a locked position, in which the second mobile (4) cannot engage mechanically with the first mobile (3); and
a support (5) on which the second mobile (4) is mounted,
wherein the support (5) is thermally distortable to move the second mobile (4) from the locked position to the coupled position and/or inversely.

2. The micromechanical device according to claim 1, wherein the support (5) comprises at least in part, preferably completely, a memory material that is thermally distortable when it exceeds a threshold temperature.

3. The micromechanical device according to claim 2, wherein the threshold temperature is comprised between 60°C and 80°C.

4. The micromechanical device according to claim 1, wherein the support (5) is a lever.

5. The micromechanical device according to claim 4, wherein the lever comprises a curved portion (7), the lever straightening to move the second mobile (4) from the locked position to the coupled position.

6. The micromechanical device according to claim 5, wherein the second mobile (4) is arranged in or in the immediate vicinity of the curved portion (7) of the lever.

7. The micromechanical device according to claim 4, wherein the micromechanical device (1) comprises an arbor (8) arranged perpendicularly to a first end (9) of the lever, to form a pivot around which the lever can turn.

8. The micromechanical device according to claim 1, wherein the support (5) comprises a pinion (6) meshing with the second mobile (4).

9. The micromechanical device according to claim 1, wherein the first mobile (3) and the second mobile (4) are gear wheels.

10. The micromechanical device according to claim 1, wherein it comprises a return spring for pushing the second mobile (4) back into the locked position.

11. A horology movement, comprising the micromechanical device (1) according to claim 1.

12. The horology movement according to claim 11, further comprising a plate (11) or a bar provided with a bed (12) for the support (5).

13. The horology movement according to claim 12, whereing the bed (12) comprises a flange (13) forming a support for a second end (15) of the lever.

14. A timepiece comprising the horology movement according to claim 11.
